(19) United States
(12) Patent Application Publication
(10) Pub. No.: US 2015/0137907 A1
(43) Pub. Date: May 21, 2015

(54) DIRECTIONAL COUPLER HAVING HIGH ISOLATION

(71) Applicant: Electronics and Telecommunications Research Institute, Daejeon (KR)

(72) Inventors: Hong Gu JI, Daejeon (KR); In Kwon JU, Daejeon (KR); In Bok YOM, Daejeon (KR)

(21) Appl. No.: 14/535,476

(22) Filed: Nov. 7, 2014

(30) Foreign Application Priority Data
Nov. 20, 2013 (KR) 10-2013-0141336

(51) Int. Cl. H01P 5/18

(52) U.S. Cl. CPC H01P 5/184
USPC 333/116

(57) ABSTRACT

Provided is a directional coupler having high isolation, the directional coupler including a first directional coupler including a first main line and a first sub-line, and a second directional coupler including a second main line and a second sub-line, wherein the first directional coupler is connected to the second directional coupler in series.

### CROSS-REFERENCE TO RELATED APPLICATION

This application claims the priority benefit of Korean Patent Application No. 10-2013-0141336, filed on Nov. 20, 2013, in the Korean Intellectual Property Office, the disclosure of which is incorporated herein by reference.

### BACKGROUND

1. Field of the Invention

The present invention relates to a configuration of a directional coupler having high isolation.

2. Description of the Related Art

A directional coupler may include a main line used to propagate a high frequency signal, and a sub-line disposed in parallel with the main line, to be electromagnetically coupled with the main line.

FIG. 1 is a diagram illustrating a configuration of a directional coupler according to a related art. Referring to FIG. 1, a portion of a high frequency signal input from a terminal of a main line 101 may be output to a terminal of a sub-line 102 through an electromagnetic coupling between the main line 101 and the sub-line 102.

Propagation of the high frequency signal may occur between the main line 101 and the sub-line 102 such that impedances of the main line 101 and the sub-line 102 are determined. Here, the propagation may be called an even mode or an odd mode. When a phase velocity of the even mode is identical to a phase velocity of the odd mode, and lengths of the main line 101 and the sub-line 102 are determined to be ¼ times a wavelength of the high frequency signal, the high frequency signal input from an input (IN) terminal of the main line 101 may not be output through an output (OUT) terminal of the sub-line 102, thereby achieving favorable isolation.

In FIG. 1, when a high frequency is input to the IN terminal, a signal corresponding to a degree of coupling with the OUT terminal may be output to a coupled (CUP) terminal and a termination (TERM) terminal may be shorted through an impedance matching. In this instance, isolation of the directional coupler may correspond to the signal input from the OUT terminal to the CUP terminal.

In comparison between a directional coupler having a relatively high degree of coupling, for example, −3 decibels (dB), and a 30 dB isolation, and a directional coupler having a relatively low degree of coupling, for example, −30 dB and −30 dB isolation, the former directional coupler having a relatively low degree of coupling may obtain insufficient isolation while the latter directional coupler having a relatively high degree of coupling may achieve sufficient isolation.

This issue may occur due to a physical characteristic that a microstrip transmission line has two different media properties.

### SUMMARY

An aspect of the present invention provides a directional coupler to obtain high isolation of a microstrip directional coupler through a simple coupling in order to solve an issue caused due to a physical characteristic that a microstrip transmission line has insufficient isolation when passing two different media.

According to an aspect of the present invention, there is provided a directional coupler including a first directional coupler including a first main line and a first sub-line, and a second directional coupler including a second main line and a second sub-line, wherein the first directional coupler is connected to the second directional coupler in series.

The first main line may be connected to the second main line using a microstrip disposed therebetween, and the first sub-line may be connected to the second sub-line using a first capacitor, a second capacitor, and an inductor disposed therebetween.

A first end of the first sub-line may be connected to a first end of the first capacitor, a first end of the second sub-line may be connected to a first end of the second capacitor, a first end of the inductor may be connected between a second end of the first capacitor and a second end of the second capacitor, and a second end of the inductor may be connected to a ground.

According to another aspect of the present invention, there is also provided a directional coupler including a first microstrip, a second microstrip, a third microstrip, a fourth microstrip, and a fifth microstrip disposed between the first microstrip and the second microstrip to connect the first microstrip and the second microstrip, wherein the third microstrip is connected to the fourth microstrip in series.

The third microstrip may be connected to the fourth microstrip using a first capacitor, a second capacitor, and an inductor.

A first end of the third microstrip may be connected to a first end of the first capacitor, a first end of the fourth microstrip may be connected to a first end of the second capacitor, a first end of the inductor may be connected between a second end of the first capacitor and a second end of the second capacitor, and a second end of the inductor may be connected to a ground.

The first microstrip and the second microstrip may be included in a main line, and the third microstrip and the fourth microstrip may be included in a sub-line.

Isolation of the directional coupler may be less than or equal to −40 decibels (dB).

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a directional coupler according to a related art;

FIG. 2 is a diagram illustrating a configuration of a directional coupler having high isolation according to an embodiment of the present invention;

FIGS. 3A and 3B are diagrams illustrating a configuration of a directional coupler and a simulation test result of the directional coupler, respectively, according to a related art; and

FIGS. 4A and 4B are diagrams illustrating a design configuration of a directional coupler and a simulation test result of the directional coupler, respectively, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a structure of a directional coupler having high isolation will be described with reference to the accompanying drawings.

The present invention discloses a method of designing two transmission lines electromagnetically coupled in a directional coupler. To this end, a directional coupler having a relatively low degree of coupling may be designed based on a microstrip structure or, to solve an issue of depletion of isolation, a scheme of incorporating a transmission line having an appropriate electrical length may be adopted for a design.

When two directional couplers are connected to each other, isolation of a directional coupler having a low degree of coupling may be improved through a coupling performed using a transmission line, a capacitor, and an inductor.

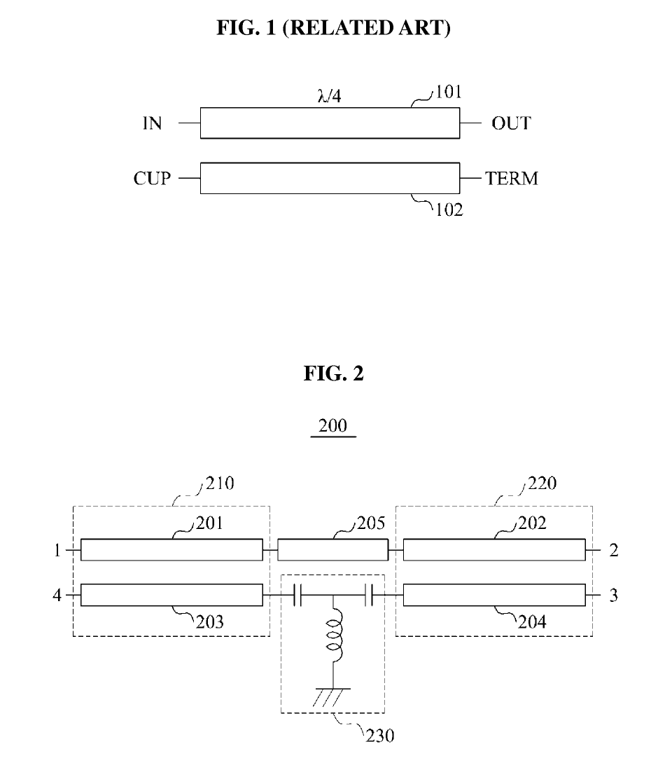

FIG. 2 is a diagram illustrating a configuration of a directional coupler 200 having high isolation according to an embodiment of the present invention. Referring to FIG. 2, the directional coupler 200 may be provided in a configuration in which two directional couplers, for example, a first directional coupler 210 and a second directional coupler 220, which are similar to the general directional coupler of FIG. 1 are connected to each other, and internal characteristics of the first directional coupler 210 may be identical to or differ from internal characteristics of the second directional coupler 220.

The first directional coupler 210 may include a first main line 201 and a first sub-line 203, and the second directional coupler 220 connected to the first directional coupler 210 may include a second main line 202 and a second sub-line 204.

When the first directional coupler 210 is connected to the second directional coupler 220, the first main line 201 may be connected to the second main line 202 in series, and the first sub-line 203 may be connected to the second sub-line 204 in series. Each of the first main line 201, the second main line 202, the first sub-line 203, and the second sub-line 204 may be configured using a microstrip.

In this instance, the first main line 201 may be connected to the second main line 202 using a microstrip 205 disposed therebetween. The first sub-line 203 may be connected to the second sub-line 204 using a capacitor & inductor 230 disposed therebetween. Here, the capacitor & inductor 230 may include a first capacitor, a second capacitor, and an inductor.

A connection form according to an example embodiment may be based on the configuration of FIG. 2. Descriptions about the first main line 201 and the second main line 202 have been provided above and thus, descriptions about a connection structure among the first sub-line 203, the second sub-line 204, and the capacitor & inductor 230 will be provided.

A first end of the first sub-line 203 may be connected to a first end of the first capacitor, and a first end of the second sub-line 204 may be connected to a first end of the second capacitor. The inductor may be connected between the first capacitor and the second capacitor. A first end of the inductor may be connected between a second end of the first capacitor and a second end of the second capacitor, and a second end of the inductor may be connected to a ground.

Each of the lines included in the directional coupler 200 of FIG. 2 may be configured using the microstrip. Thus, a first microstrip may be connected to a second microstrip using the microstrip 205, and a third microstrip may be connected to a fourth microstrip using the first capacitor, the second capacitor, and the inductor.

Individually describing each line in the structure of the directional coupler 200 of FIG. 2, each line may be configured as a microstrip line. Accordingly, the first main line 201, the second main line 202, the first coupled line 203, the second coupled line 204, and the microstrip 205 disposed between the first main line 201 and the second main line 202 may also be referred to a first microstrip 201, a second microstrip 202, a third microstrip 203, a fourth microstrip 204, and a fifth microstrip 205, respectively. The first microstrip 201, the second microstrip 202, the third microstrip 203, and the fourth microstrip 204 may be connected using the fifth microstrip 205 and the capacitor & inductor 230.

The first microstrip 201 may be connected to the second microstrip 202 in series, and the third microstrip 203 may be connected to the fourth microstrip 204 in series.

In this instance, the first microstrip 201 may be connected to the second microstrip 202 using the fifth microstrip 205 disposed therebetween, and the third microstrip 203 may be connected to the fourth microstrip 204 in series using the capacitor & inductor 230 disposed therebetween.

For example, the first end of the third microstrip 203 may be connected to the first end of the first capacitor, and the first end of the fourth microstrip 204 may be connected to the first end of the second capacitor. The inductor may be connected between the first capacitor and the second capacitor. The first end of the inductor may be connected between the second end of the first capacitor and the second end of the second capacitor, and the second end of the inductor may be connected to the ground.

Based on the configuration of the directional coupler 200, high isolation may be achieved and the high isolation may be maintained when a directional coupler having a relatively low coupling coefficient is connected.

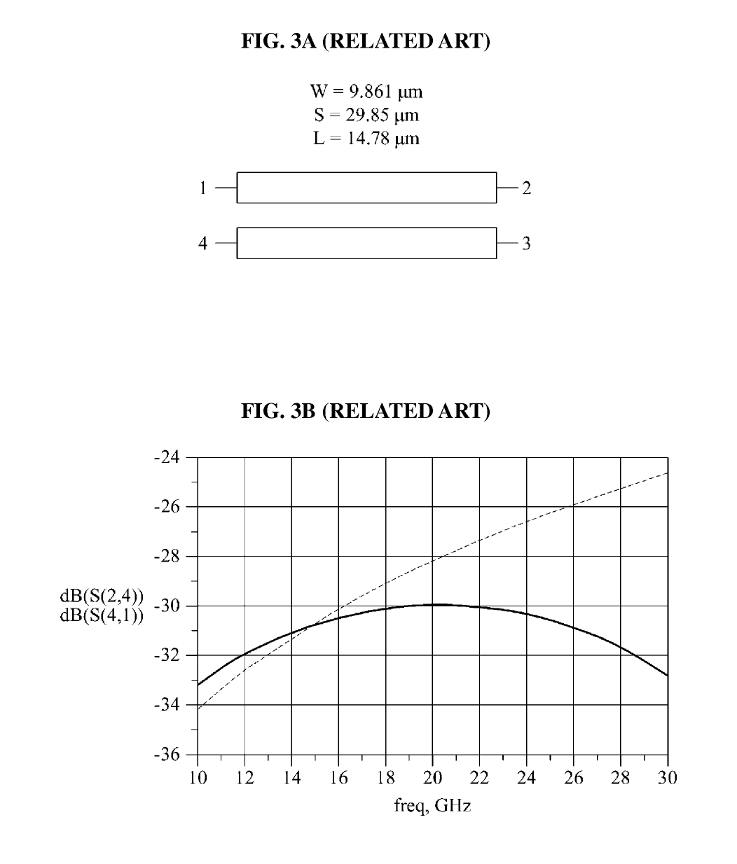

FIGS. 3A and 3B are diagrams illustrating a design of a directional coupler and a simulation test result of the directional coupler, respectively, according to a related art.

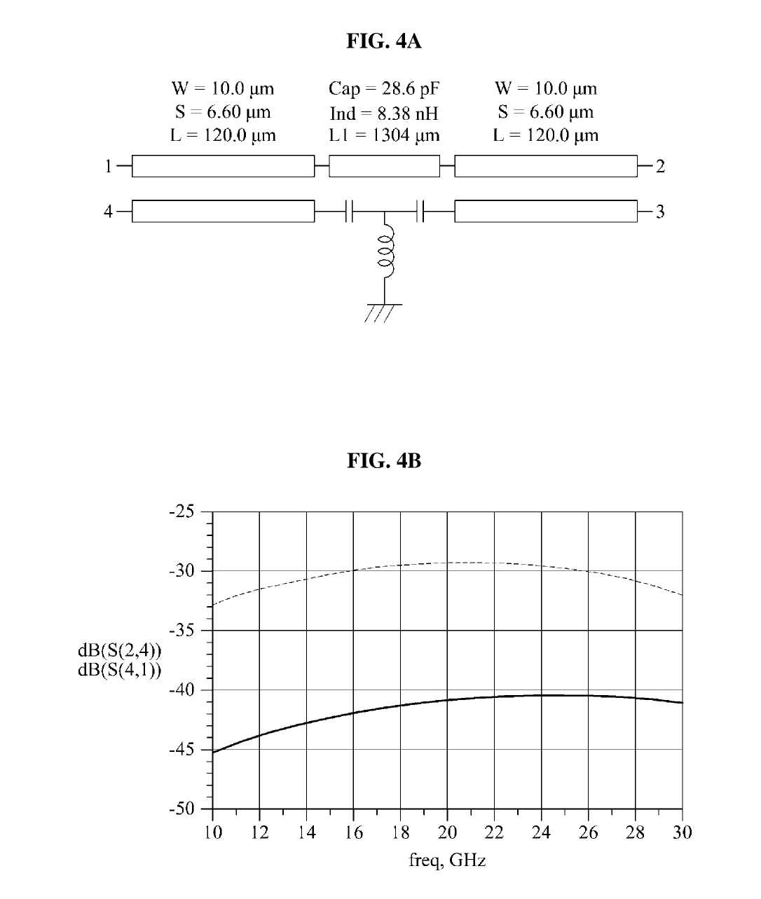

FIGS. 4A and 4B are diagrams illustrating a design configuration of a directional coupler and a simulation test result of the directional coupler, respectively, according to an embodiment of the present invention.

In the general directional coupler of FIG. 3A, a width of each line may be 9.861 micrometers (μm), a space between the two lines may be 29.85 μm, and a length of each of the two lines may be 14.78 μm. Characteristics of the conventional directional coupler of FIG. 3A may be indicated by a graph of FIG. 3B. In the graph of FIG. 3B, S (4, 1) indicated using a solid line may indicate a coupling coefficient, S (2, 4) indicated using a broken line may indicate isolation, and the characteristics may be expressed based on a dB scale. Hereinafter, S may indicate a scattering parameter. Since the graph is based on the dB scale, a negative quantity may be included on the graph.

In FIG. 3B, the graph illustrates a result of simulation performed on an ideal substrate of which a permittivity is 9.6 and a thickness is 10 μm, to obtain isolation in a 20 gigahertz (GHz) band. As shown in the graph, a difference between the isolation and a coupling coefficient obtained in the 20 GHz band may be approximately 2 dB.

Since the directional coupler is used to separate an incident wave and a reflected wave in general, the isolation of the directional coupler may need to be maintained with a relatively high level. Accordingly, referring to FIG. 4A, a coupling coefficient and isolation indicated by a graph of FIG. 4B may be achieved based on a configuration in which two directional couplers are connected to each other using capacitors and an inductor. Here, each of the two directional couplers may include two lines. A width of each of the two lines may be 10.0 μm, a space between the two lines may be 6.60 μm, and a length of each of the two lines may be 120 μm.

In FIG. 4B, the graph illustrates the coupling coefficient of S (4, 1) and the isolation of S (2, 4) based on the dB scale. As shown in the graph, the directional coupler may be designed to have high isolation, for example, isolation less than or equal to −40 dB and −30 dB coupling efficient in the 20 GHz band.

According to an aspect of the present invention, it is possible to solve the aforementioned issue by designing a directional coupler having high isolation such that the high isolation is also maintained in a directional coupler having a low coupling coefficient. A method of the designing may be simple so as to be easily applied.

While the present invention has been shown and described with reference to a few exemplary embodiments and the accompanying drawings, it will be apparent to those skilled in the art that various modifications and variations can be made in the present invention without departing from the spirit or scope of the invention. For example, adequate effects of the present invention may be achieved even if the foregoing processes and methods may be carried out in different order than described above, and/or the aforementioned elements, such as systems, structures, devices, or circuits, may be combined or coupled in different forms and modes than as described above or be substituted or switched with other components or equivalents.

Thus, it is intended that the present invention cover the modifications and variations of this invention provided they come within the scope of the appended claims and their equivalents.

What is claimed is:

1. A directional coupler comprising:
a first directional coupler comprising a first main line and a first sub-line; and
a second directional coupler comprising a second main line and a second sub-line,
wherein the first directional coupler is connected to the second directional coupler in series.

2. The directional coupler of claim 1, wherein the first main line is connected to the second main line using a microstrip disposed therebetween, and
the first sub-line is connected to the second sub-line using a first capacitor, a second capacitor, and an inductor disposed therebetween.

3. The directional coupler of claim 2, wherein a first end of the first sub-line is connected to a first end of the first capacitor,
a first end of the second sub-line is connected to a first end of the second capacitor,
a first end of the inductor is connected between a second end of the first capacitor and a second end of the second capacitor, and
a second end of the inductor is connected to a ground.

4. A directional coupler comprising:
a first microstrip;
a second microstrip;
a third microstrip;
a fourth microstrip; and
a fifth microstrip disposed between the first microstrip and the second microstrip to connect the first microstrip and the second microstrip,
wherein the third microstrip is connected to the fourth microstrip in series.

5. The directional coupler of claim 4, wherein the third microstrip is connected to the fourth microstrip using a first capacitor, a second capacitor, and an inductor disposed therebetween.

6. The directional coupler of claim 5, wherein a first end of the third microstrip is connected to a first end of the first capacitor,
a first end of the fourth microstrip is connected to a first end of the second capacitor,
a first end of the inductor is connected between a second end of the first capacitor and a second end of the second capacitor, and
a second end of the inductor is connected to a ground.

7. The directional coupler of claim 5, wherein the first microstrip and the second microstrip are included in a main line, and
the third microstrip and the fourth microstrip are included in a sub-line.

8. The directional coupler of claim 4, wherein isolation of the directional coupler is less than or equal to −40 decibels (dB).
